(19) United States
(12) Patent Application Publication
(10) Pub. No.: US 2003/0185570 A1
(43) Pub. Date: Oct. 2, 2003

(54) Systems and methods for gain pre-compensation in optical communication systems

(76) Inventors: M. Imran Hayee, Woodstock, MD (US); William Shieh, Clarksville, MD (US); Thomas Clark, Columbia, MD (US)

Correspondence Address: HARRITY & SNYDER, LLP, 11240 WAPLES MILL ROAD, SUITE 300, FAIRFAX, VA, 22030, US

(21) Appl. No.: 10/107,135

(22) Filed: Mar. 28, 2002

(51) Int. Cl. H04J 14/02; H04B 10/18; H04B 10/16

(52) U.S. Cl. 398/97; 398/34; 398/177; 398/158

(57) ABSTRACT

A system for reducing gain ripple of an optical system that includes a set of spans further includes a multiplexing unit and an optical filter. The multiplexing unit multiplexes a plurality of optical signals. The optical filter filters the multiplexed optical signals, prior to transmission of the multiplexed signals over the spans of the optical system, to reduce gain ripple.

### FIELD OF THE INVENTION

The present invention relates generally to optical transmission systems and, more particularly, to systems and methods for pre-compensating for gain ripple in an optical transmission system.

### BACKGROUND OF THE INVENTION

Long haul and ultra long haul optical communication systems typically consist of optical terminals interconnected via multiple system spans, with each span including a repeater and an optical link. In such systems, optical signals of different wavelengths are wavelength division multiplexed in the terminal for transmission over the system spans. The repeaters of each span amplify the multiplexed optical signals as the signals traverse the spans of the system.

Various types of optical amplification schemes can be used such as, for example, schemes employing erbium-doped fiber amplifiers (EDFAs). EDFAs employ a length of erbium-doped fiber in conjunction with a pump laser that injects a pumping signal having a wavelength of, for example, approximately 1480 nm. This pumping signal interacts with the f-shell of the erbium atoms to stimulate energy emissions that amplify an optical signal having a wavelength of about 1550 nm. One drawback of EDFA amplification techniques is the relatively narrow bandwidth within which amplification occurs, (i.e., the so-called erbium spectrum). Future generation systems will likely require wider bandwidths than that available from EDFA amplification in order to increase the number of channels (wavelengths) available on each fiber, thereby increasing system capacity.

Raman amplification is one amplification scheme that can provide a broad and relatively flat gain profile over a wider wavelength range than that which has conventionally been used in optical communication systems employing EDFA amplification techniques. Raman amplifiers employ a phenomenon known as “stimulated Raman scattering” to amplify the transmitted optical signal. In stimulated Raman scattering, radiation from a pump radiation source interacts with a gain medium through which the optical transmission signal passes to transfer power to that optical transmission signal. One of the benefits of Raman amplification is that the gain medium can be the optical fiber itself, (i.e., no specially doped fiber is required as in EDFA techniques). For example, Raman amplification can be performed by coupling a pump laser, which generates a light beam having a predetermined wavelength, at points along the optical fiber. The wavelength of the pump laser is selected such that the vibration energy generated by the pump laser beam's interaction with the gain medium, (e.g., the optical fiber itself), is transferred to the transmitted optical signal in a particular wavelength range. This wavelength range establishes the gain profile of the pump laser, the amplitude of which varies as a function of wavelength.

However, the typical gain profile of 20-30 nm for a single wavelength pump laser is too narrow to support the wide bandwidths of, (e.g., 100 nm or more), that are desired for next generation optical communication systems. To broaden and flatten the gain profile, Raman amplifiers can use multiple pump lasers for generating pump laser wavelengths over a broad wavelength range. The individual gain profiles attributable to each pump laser sum to provide a combined gain profile that can be used to amplify a transmitted optical signal over a much wider bandwidth.

As they propagate through each span, various effects cause optical signals on different wavelengths to receive different amounts of gain. Gain ripple (which refers to the difference between a maximum gain received by one optical signal at a first wavelength minus a minimum gain received by another optical signal transmitted at another wavelength) is generally considered to be an undesirable characteristic in WDM optical communication systems since it reduces the usable bandwidth, More specifically, in systems which experience significant gain ripple, the higher gain channels may reach saturation levels and reduce the gain experienced by lower gain channels. These lower gain channels then dictate system performance.

Therefore, there exists a need for systems and methods that can reduce gain ripple associated that accumulates across the spans of an optical transmission system.

### SUMMARY OF THE INVENTION

Systems and methods consistent with the present invention address this need and others by pre-compensating for accumulated gain ripple at a terminal before the optical signals are transmitted across the spans of the optical system. Pre-compensation may be achieved using a filter installed in a terminal of the optical system. The parameters of the filter may be selected in response to gain ripple measured in the system. For example, a functional inverse of a measured gain ripple function may be used to select the parameters of the filter to reduce gain ripple. Through design of the filter parameters, the higher gain channels of the system will not reach saturation levels that reduce the gain of neighboring lower gain channels. By controlling gain saturation, pre-compensation consistent with the present invention equalizes the system gain level, which also equalizes and improves the SNR and/or bit-error-rate (BER) of the system.

In accordance with the purpose of the invention as embodied and broadly described herein, a method of gain pre-compensation in an optical communication system includes measuring gain associated with each of a plurality of wavelength channels in the optical communication system; and filtering, in a transmit terminal, optical signals to be transmitted over the optical communication system, based on the measured gain.

In another implementation consistent with the present invention, a method of transmitting signals in an optical system including a set of spans is provided. The method includes filtering first optical signals, prior to transmission over the set of spans, using first filter parameters; determining power-related parameters over a number of spans of the set of spans; and filtering second optical signals, prior to transmission over the set of spans, using second filter parameters derived from the determined power-related parameters.

In a further implementation consistent with the present invention, a method of reducing optical system gain ripple includes measuring gain ripple over a number of spans of a n span optical system; and adjusting pre-compensation filter parameters to filter optical signals, prior to transmission of the optical signals over the spans of the optical system, to reduce measured gain ripple.

### BRIEF DESCRIPTION OF THE DRAWINGS

The accompanying drawings, which are incorporated in and constitute a part of this specification, illustrate embodiments of the invention and, together with the description, explain the invention. In the drawings,

FIG. 1 illustrates an exemplary system in which systems and methods consistent with the present invention may be implemented;

FIG. 2 illustrates exemplary land terminals and the system underwater portion of FIG. 1, prior to underwater deployment, in which the system includes a gain ripple monitor consistent with the present invention;

FIG. 3 illustrates exemplary land terminals and the system underwater portion of FIG. 1, subsequent to underwater deployment, in which a land terminal includes a filter designed to reduce gain ripple consistent with the present invention;

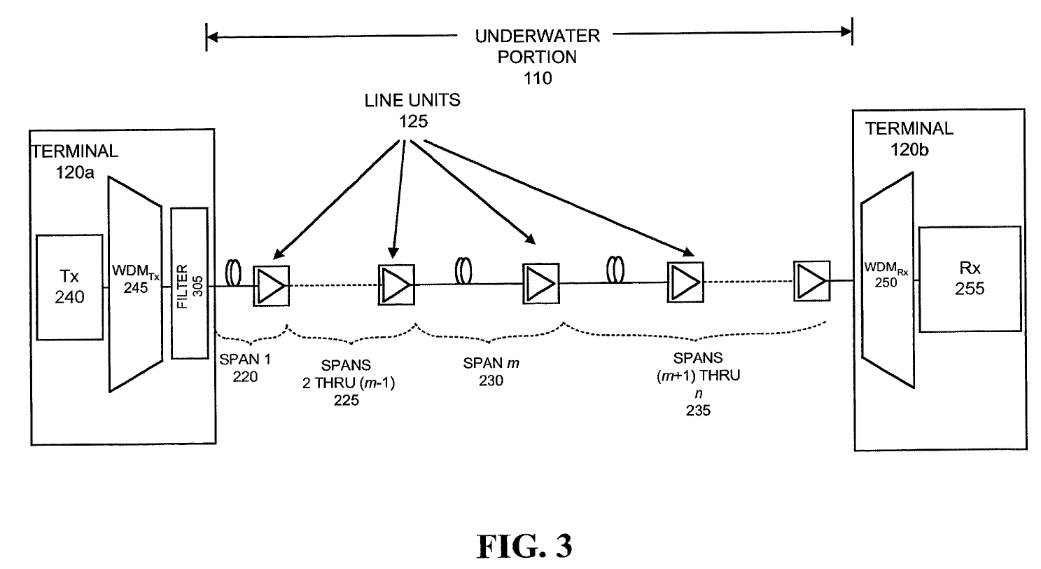

FIG. 4 illustrates an exemplary terminal that includes a filter designed to reduce gain ripple consistent with the present invention;

FIG. 5 is a flowchart that illustrates an exemplary process, consistent with the present invention, for pre-compensating for measured gain ripple in an optical transmission system; and

FIG. 6 shows experimental simulation data for an optical transmission system employing gain pre-compensation consistent with the present invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with the present invention provide mechanisms for pre-compensating for gain ripple in an optical transmission system. Pre-compensation, consistent with the present invention, may be applied to optical signals at a terminal of the optical system before signals are transmitted across the spans of the system. Pre-compensation may be achieved using a filter installed in a terminal of the optical system, where the parameters of the filter can be designed in response to gain ripple measured over a number of spans of the system, (e.g., at approximately the midpoint of the system). Through gain pre-compensation, gain saturation can be controlled, thus improving the overall gain level and the SNR of the system.

### Exemplary System

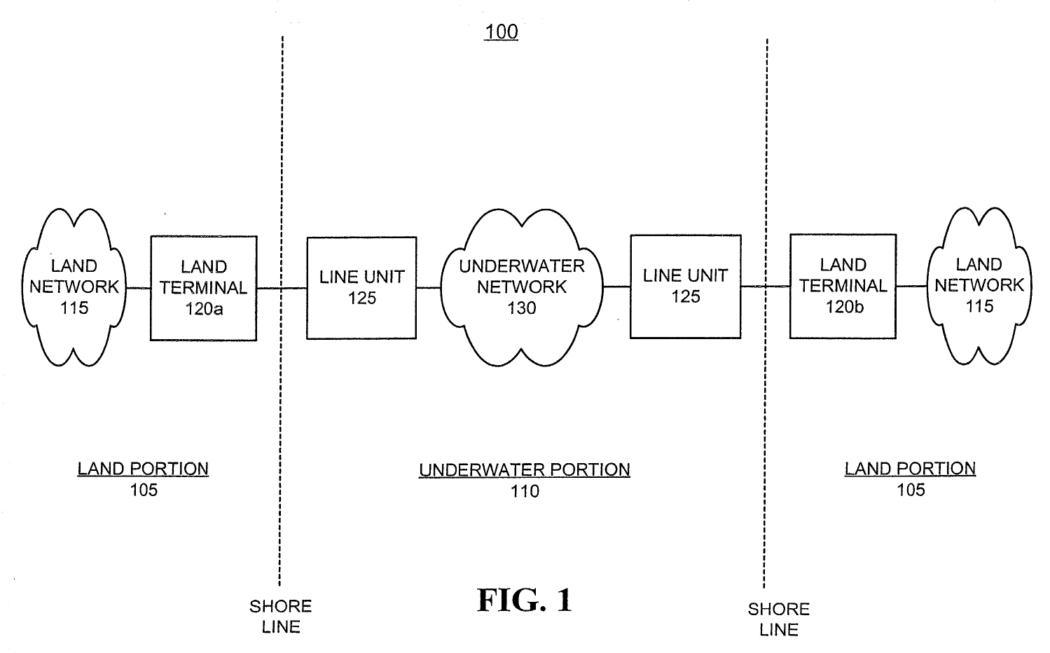

FIG. 1 illustrates an exemplary system 100 in which systems and methods consistent with the present invention may be implemented. System 100 may include two land communication portions 105 that are interconnected via an underwater communication portion 110. The land portions 105 may include land networks 115 and land terminals 120. The underwater portion 110 may include line units 125 (sometimes referred to as “repeaters”) and an underwater network 130. Two land networks 115, land terminals 120a and 120b, and line units 125 are illustrated for simplicity. System 100 may include more or fewer devices and networks than are illustrated in FIG. 1.

Land network 115 may include one or more networks of any type, including a Public Land Mobile Network (PLMN), Public Switched Telephone Network (PSTN), local area network (LAN), metropolitan area network (MAN), wide area network (WAN), Internet, or Intranet. The one or more PLMNs may further include packet-switched subnetworks, such as, for example, General Packet Radio Service (GPRS), Cellular Digital Packet Data (CDPD), and Mobile IP sub-networks. Land terminals 120 include devices that convert signals received from the land network 115 into optical signals for transmission to the line unit 125, and vice versa. The land terminals 120 may connect to the land network 115 via wired, wireless, or optical connections. In an implementation consistent with the present invention, the land terminals 120 connect to the line units 125 via an optical connection.

The land terminals 120 may include, for example, long reach transmitters/receivers that convert signals into an optical format for long haul transmission and convert underwater optical signals back into a format for transmission to the land network 115. The land terminals 120 may also include wave division multiplexers and optical conditioning units that multiplex and amplify optical signals prior to transmitting these signals to line units 125, and line current equipment that provides power to the line units 125 and underwater network 130.

The underwater network 130 may include groups of line units and/or other devices capable of amplifying and routing optical signals in an underwater environment. The line units 125 include devices capable of receiving optical signals and transmitting these signals to other line units 125 via the underwater network 130. The line units 125 may include wave division multiplexers and optical conditioning units that multiplex and amplify received optical signals prior to re-transmitting these signals via underwater network 130.

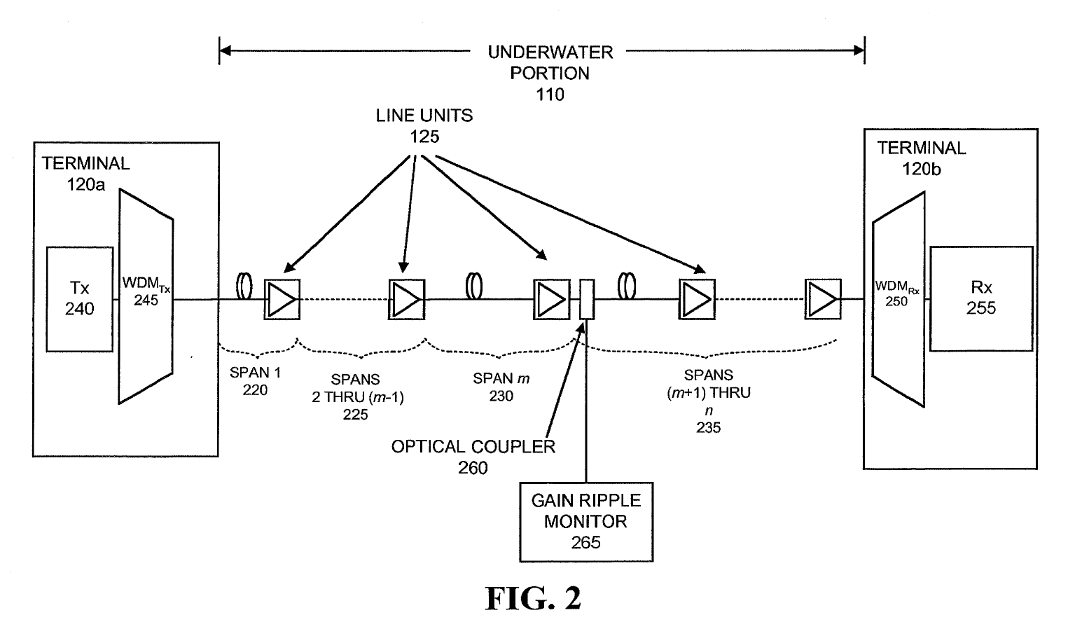

FIG. 2 illustrates terminals 120a and 120b, and exemplary spans of underwater portion 110, of system 100 prior to underwater deployment. Terminals 120a and 120b can be interconnected via a system of n spans (e.g., spans 1 220, spans 2 through (m−1) 225, span m 230 and spans (m+1) through n 235) of links and line units 125, with each span including a single link and a single line unit. Each link may include an optical fiber that can transmit wavelength division multiplexed optical signals between line units 125. The underwater portion 110 may include more or fewer devices than are illustrated in FIG. 2.

Terminal 120a may include an optical transmitter (Tx) 240 and a wavelength division multiplexer (WDM_{Tx}) 245. Tx 240 may include laser diodes for transmitting optical signals at specified wavelengths (λ₁−λ_{N}). Tx 240 may also include optical conditioning units (not shown), such as attenuators and/or filters, for controlling the optical output power of Tx 240. WDM_{Tx} 245 may include conventional components for multiplexing the various wavelength optical signals from Tx 240 into wavelength multiplexed optical signals for transmission via the n spans of system 100.

Terminal 120b may include wavelength division multiplexer (WDM_{Rx}) 250 and optical receiver (Rx) 255. WDM_{Rx} 250 may demultiplex the wavelength division multiplexed signal received from the spans of system 100. Rx 255 may receive the demultiplexed optical signals and convert the optical signals into electrical signals for transmission via land network 115.

System 100 may further include an optical coupler (tap) 260 and a gain ripple monitor 265. Optical coupler 260 may couple with a link of any span of the system from terminal 120a (e.g., the link after the mth span) prior to deployment of underwater portion 110. Optical coupler 260 couples optical signals carried by the set of spans to gain ripple monitor 265. Gain ripple monitor 265 may measure the gain excursion/gain ripple of the coupled signals so that the appropriate filter parameters for a filter can be selected to provide gain pre-compensation at land terminal 120a.

FlG. 3 illustrates the terminals 120a and 120b, and the exemplary spans of underwater portion 110, of system 100, subsequent to underwater deployment. Prior to underwater deployment, gain ripple monitor 265 may be removed from system 100 and filter 305, designed to provide gain pre-compensation according to the previously measured gain excursion/gain ripple measurement, may be installed in land terminal 120a. Filter 305 may filter the multiplexed optical signals received from WDM_{Rx} 255 before transmission over the spans of system 100.

### Exemplary Terminal

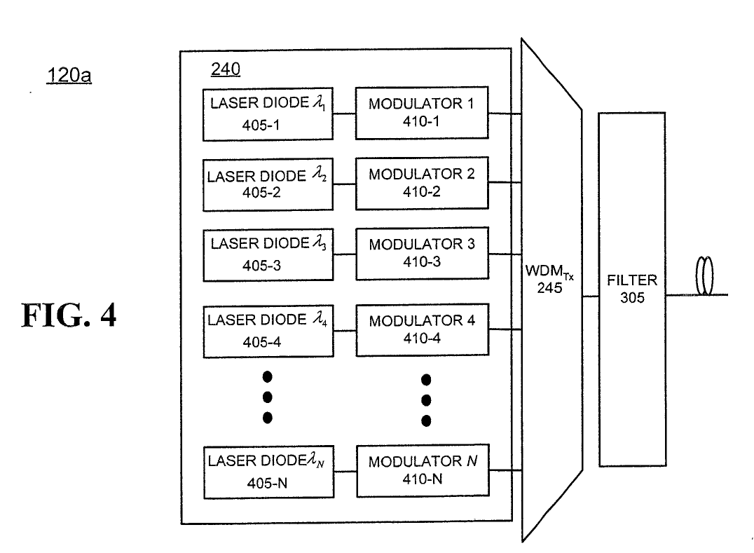

FIG. 4 illustrates a block diagram of exemplary components of Tx 240 of terminal 120a consistent with the present invention. Tx 240 may include N laser diodes (405-1 through 405-N) and N modulators (410-1 through 410-N). Each of the N laser diodes may produce an optical signal at a specified wavelength (λ) and may include circuitry for biasing the laser diode to produce a desired output power. The N modulators may modulate the output of each associated laser diode by information signals that are to be transmitted over system 100.

### Exemplary Gain Pre-Compensation

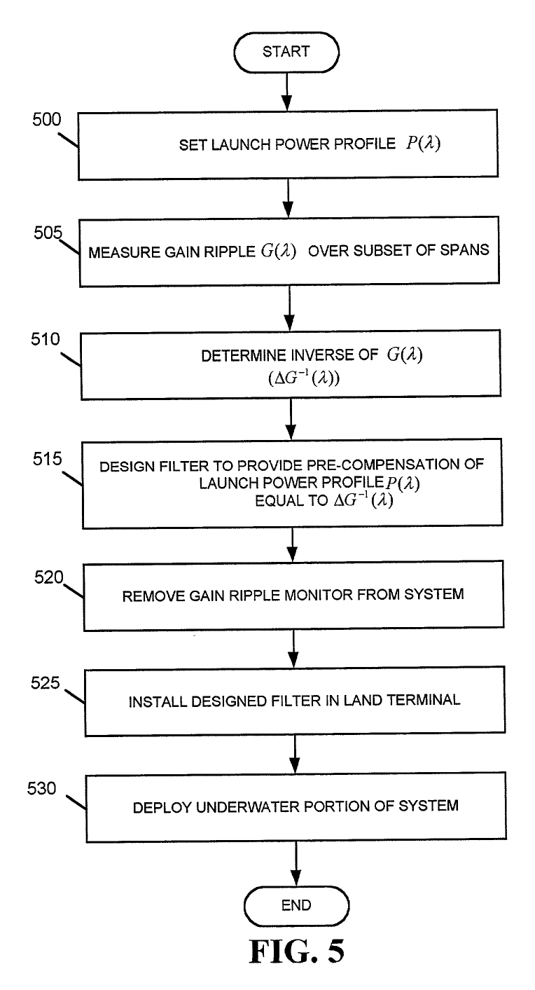

FIG. 5 is a flowchart that illustrates an exemplary process, consistent with the present invention, for pre-compensating optical system gain using measured gain ripple. The process may begin by setting a launch power profile P(λ) [act 500]. The launch power profile may be set by appropriately biasing each laser diode (405-1 through 405-N). The gain ripple G(λ) may then be measured over a subset (e.g., m of n spans) of system spans [act 505]. For example, gain ripple monitor 265 may, via optical coupler 260, measure the gain ripple at span m 230 of system 100, (i.e., at approximately the midpoint of the system).

An inverse ΔG^{31 1}(λ)=G(λ/minG(λ)) of the measured G(λ) may be determined [act 510]. Filter 305 may then be designed to provide pre-compensation of the launch power profile P(λ) equal to ΔG⁻¹(λ) [act 515]. In some embodiments, a functional inverse ΔG⁻¹(λ) of the measured G(λ) may be determined, and filter parameters of filter 305 may be manually selected and fixed according to ΔG⁻¹(λ). Gain ripple monitor 265 may then be removed from system 100 [act 520] prior to system deployment. The designed filter 305 may then be installed in land terminal 120a for gain pre-compensation of the optical channels prior to their transmission across the spans of system 100 [act 525]. Portion 110 of system 100 may then be deployed (e.g., underwater) [act 530]. In some embodiments, acts 500-515 may be selectively repeated to optimize gain ripple reduction in optical system 100. In other embodiments, however, only one iteration may be performed.

### System Performance

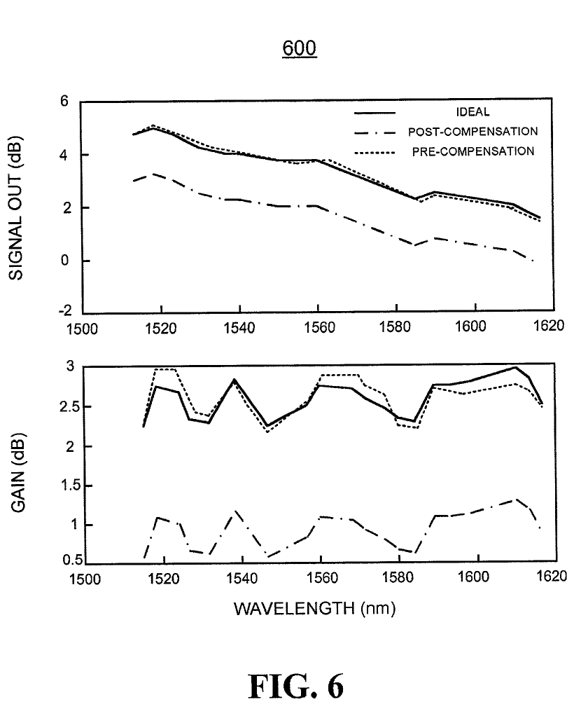

FIG. 6 illustrates simulated performance plots 600 of an exemplary 60 km span Raman amplified optical transmission system employing gain pre-compensation consistent with the present invention. Examples of Raman amplified optical communication systems may be found in U.S. patent application Ser. No. ______, entitled “High Power Repeaters for Raman Amplified Wave Division Multiplexed Optical Communication Systems”, to Bo Pedersen et al., filed on Oct. 3, 2001, the disclosure of which is incorporated herein by reference. This particular (and purely exemplary) simulation employed steady-state bidirectional power transfer equations to simulate Raman gain (see, e.g., Photonics Letters v 11 n5 1999 p.530 to H.Kidorf) using a fourth order Runge-Kutta method. Simulation system parameters included a 60 km span length with a linearly pre-emphasized launch power profile for 250 channels of −7.4 dBm to −11.7 dBm for 1514 nm to 1616 nm. Bidirectional pumping was simulated using 120 mW co-propagating pump power at 1410 nm and 780 MW counter-propagating pump power distributed over 16 wavelenghts to achieve 0.6 dB peak to peak per span flatness. The simulation also assumes a per span gain flattening filter for the 0.6 dB deterministic gain ripple. Those skilled in the art will appreciate that these parameters can be varied in actual implementations and were selected as a purely exemplary manner in which to demonstrate some of the benefits of techniques and systems according to the present invention. The simulation was based on the introduction of a random, non-deterministic error being introduced after each span.

As is evident from the graphs in FIG. 6, pre-compensation results in nearly the same output power (upper graph) and gain (lower graph) as the ideal case (with no error). However, post-compensation (placing the filter somewhere within the set of spans or in the receiving terminal) shows approximately 1.7 dB lower power. Post-compensation, thus, which would require higher gain (i.e., more pump power and resulting in more amplitude spontaneous emission (ASE) per span) and, therefore, would have increased signal degradation as compared to pre-compensation according to the present invention.

### Conclusion

Systems and methods consistent with the present invention provide mechanisms that pre-compensate for gain ripple in an optical system by adjusting the gain of optical signals before the signals are transmitted across spans of the optical system. Pre-compensation for non-deterministic effects may be achieved by selection of the parameters of a filter installed at the transmit terminal according to gain ripple measured over a number of spans of the system. Pre-compensation consistent with the present invention provides some control of gain saturation and, thereby, increases the system gain and improves system SNR.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. While the above description focused on an underwater environment, implementations consistent with the present invention are not so limited. For example, the systems and methods disclosed herein could alternatively be implemented in ground-based, space or aerospace environments.

While series of acts have been described with regard to FIG. 5, the order of the acts may be altered in other implementations. Moreover, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

What is claimed is:

1. A method of gain pre-compensation in an optical communication system, comprising:
measuring gain associated with each of a plurality of wavelength channels in the optical communication system; and
filtering, in a transmit terminal, optical signals to be transmitted over the optical communication system, based on the measured gain.

2. The method of claim 1, wherein measuring the gain comprises measuring the gain over a number of spans of the optical communication system.

3. The method of claim 2, wherein each span of the number of spans comprises a link and at least one repeater.

4. The method of claim 1, wherein the filtering is based on an inverse of the measured gain.

5. The method of claim 1, further comprising:
selectively adjusting filtering parameters to optimize the measured gain excursion.

6. A system for gain pre-compensation in an optical communication system, comprising:
means for measuring gain associated with each of a plurality of wavelength channels in the optical communication system; and
means for filtering, in a transmit terminal, optical signals to be transmitted over the optical communication system, based on the measured gain.

7. The system of claim 6, wherein the means for measuring the gain comprises means for measuring gain over a number of spans of the optical communication system.

8. The system of claim 7, wherein each span of the number of spans comprises a link and at least one repeater.

9. The system of claim 6, wherein the filtering is based on an inverse of the measured gain.

10. The system of claim 6, further comprising:
means for selectively adjusting filtering parameters to optimize the measured gain excursion.

11. A method of transmitting signals in an optical system comprising a set of spans, the method comprising:
filtering first optical signals, prior to transmission over the set of spans, using first filter parameters;
determining power-related parameters over a number of spans of the set of spans; and
filtering second optical signals, prior to transmission over the set of spans, using second filter parameters derived from the determined power-related parameters.

12. The method of claim 11, wherein the power-related parameters comprise a gain excursion profile.

13. The method of claim 11, wherein each span of the set of spans comprises a link and at least one repeater.

14. The method of claim 12, wherein the second filter parameters are derived from an inverse of the gain excursion profile.

15. An optical transmission system, comprising:
a set of spans, wherein each span of the set of spans comprises a link and at least one repeater;
a filter configured with first filter parameters to filter first optical signals prior to transmission of the first optical signals over the set of spans; and
a monitor unit configured to determine power-related parameters over a number of spans of the set of spans,
the filter further configured with second filter parameters to filter second optical signals prior to transmission of the second optical signals over the set of spans, the second filter parameters based on the determined power-related parameters.

16. The system of claim 15, wherein the power-related parameters comprise a gain excursion power profile.

17. The method of claim 15, wherein each span of the set of spans comprises a link and at least one repeater.

18. The method of claim 15, wherein the power-related parameters comprise an inverse of a gain excursion profile.

19. A method of reducing optical system gain ripple, comprising:
measuring gain ripple over a number of spans of a n span optical system; and
adjusting pre-compensation filter parameters to filter optical signals, prior to transmission of the optical signals over the spans of the optical system, to reduce measured gain ripple.

20. The method of claim 19, wherein each span of the n spans comprises a link and at least one repeater.

21. The method of claim 19, further comprising:
selectively repeating the pre-compensation filter parameter adjustment to optimize the gain ripple reduction.

22. A system for reducing gain ripple of an optical system comprising a set of spans, the system comprising:
a multiplexing unit configured to multiplex a plurality of optical signals; and
an optical filter configured to filter the multiplexed optical signals, prior to transmission of the multiplexed signals over the spans of the optical system, to reduce gain ripple.

23. The system of claim 22, further comprising:
a monitoring unit configured to measure gain ripple over a number of spans of the optical system.

24. The system of claim 23, wherein the optical filter is configured to filter the multiplexed optical signals based on the measured gain ripple.

25. The system of claim 22, wherein each span of the optical system comprises a link and at least one repeater.

26. The system of claim 22, wherein the gain ripple comprises a gain ripple profile.

27. The system of claim 23, the monitor unit further configured to:
selectively repeat the gain ripple measurement.
